(19) United States
(12) Patent Application Publication
(10) Pub. No.: US 2023/0011978 A1
(43) Pub. Date: Jan. 12, 2023

(54) AQUA WEIGHT

(71) Applicant: MICHAEL DAVID SPINA, FUQUAY, NC (US)

(72) Inventor: MICHAEL DAVID SPINA, FUQUAY, NC (US)

(73) Assignee: MICHAEL DAVID SPINA, FUQUAY, NC (US)

(21) Appl. No.: 17/382,297

(22) Filed: Sep. 27, 2022

Related U.S. Application Data
(60) Provisional application No. 63/196,338, filed on Jun. 3, 2021.

(51) Int. Cl. A01G 27/00

(52) U.S. Cl. CPC A01G 27/003

(57) ABSTRACT

Aqua-Weight is a weight- mechanism -measuring- stand -system, that weighs the planter pot, dry, wet and current saturation water levels. Aqua-Weight balances the water saturation level of the plant and planter pot, by measuring the current weight of the plant, pot and water. The illumination of led lights show and sends results that the saturation level is llow and adequate water is needed to maintain a healthier plant life.

### SUMMARY OF THE INVENTION

The description of the invention named: “AQUA-WEIGHT”, is a planter stand for pots. The purpose is to weigh the planter pot, with the plant, add water or liquid to the planter pot, which will make the planter pot heavier, this will then engage the switch, that will power off an indicator light, that will disappear through the clear saucer trays, to show that the planter pot now has sufficient amount of water or liquid. This will prevent the plant and plant’s roots from drying out or dying from dryness. When the indicator light turns on, as for a warning indication, that water or liquid should be added to the planter pot again to prevent dryness to the plant. When enough water is added to the planter pot, the indicator light will turn back off showing you have enough water or liquid in the planter pot; which will keep the plant’s roots full of water or liquid and maintain a healthier plant.

### BRIEF DESCRIPTION OF THE FIGURES

FIG. 1 shows the side view of the planter stand.

FIG. 2 shows Top View/Side of the planter stand.

FIG. 3 shows a Whole View/Side of the planter stand.

### DETAILED DESCRIPTION OF THE INVENTION

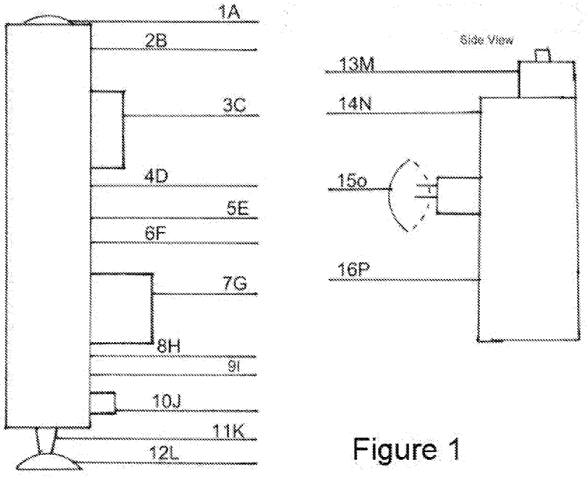

The Figure one will show the side view of the planter stand and the components labeled from the FIG. 1. black drawings.
1A. Level Bubble: Balances the plant stand.
2B. Leg of stand: Length is adjustable from 15 to 20 inches.
3C. Technology Box: Send and Receive technology data from stand of operation.
4D. Leg of stand Square width: Four corner to corner width of the leq in ¾ inches.
5E. Leg of stand: Stand will consist of 3 to 4 legs to complete application of stand structure.
6F. Leg of stand: Material of stand legs structure will be complex blend of metal to hard plastic.
7G. Battery Box option: Battery operated back up for technology and operation of plant stand.
8H. Leg of stand consists of wires with in the leg and possible water tank reservoir and mini pump.
9I.Leg of stand: braces to supports od stand connected to leg area.
10J, Power supply Box on leg stand: wired standard universal connection outlet.
11K. Leg stands adjustable feet peg: threaded rod for adjustable height length of stand leg by twisting vertically, for shorter height to taller height. Supports the plant stand balancing with level balancer labeled (1A).
12L. Lea of stand foot: Holds plant stand straight and level with adiustable movement of the foot support. Connected to (IK).
13M. Momentary switch: Togale type momentary switch that is powered and send single with in the mm adjustable press and release lever.
14N. Threaded mm rod with support holds, balances and supports the momentary switch in mm length adjusting.
15O. Twist knob attachment attaches to threaded rod that supports the momentary switch. Helps turn threaded rod to mm intervals in length as increase or decreases in length.
16P. Threaded mm rod shaft casing supports threaded rod in connection to plant stand.

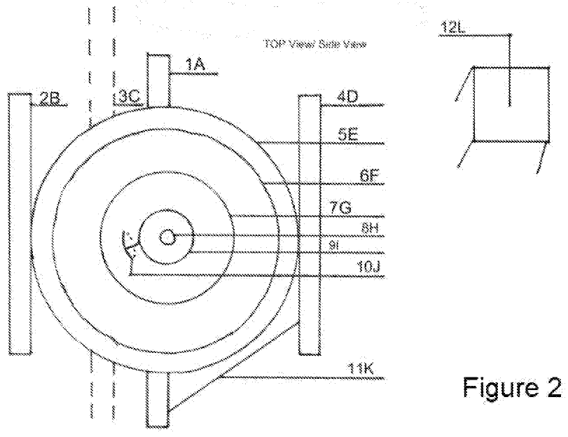

The Figure two will show the Top view and Side view of the planter stand and the components labeled from the FIG. 2. black drawings.
1A. Plant stand leg: Rear connected triangle shape for plant stand structure positioning.
2B. Plant stand leg: Side connected as triangle shape for plant stand structure positioning.
3C. Plant stand leg: possible additionally 4th leg connection in square shape for plant stand structure positioning.
4D. Plant stand leg: Side connected as triangle shape for plant stand structure positioning.
5E. Plant Disk Top: First tier disk of planter stand that holds planter pot with plant with drain holes.
6F. Plant Disk Top: Second tier disk that hold drain water from first tier planter pot. Removable to wash and clean.
7G. Plant Disk Top: Third tier disk that holds mechanics of planter stand as: springs, shock absorbers, led lights, wires, direct connection with momentary switch and technology controllers.
8H. Momentary switch location: center under third tier disk for balanced weighing of planter pot, controlled press and releasing of momentary switch shaft.
9I. Threaded rod shaft case: supported case and rod in center location under third tier disk. Supports momentary switch for balanced weigh mechanism.
10J. Twist knob: moves the threaded mm intervals of rod length by twisting clockwise to counterclockwise for desired height connection for the momentary switch to third tier disk on planter pot.
11K. Support brackets: connected to planter pot legs for strong stand support.
12L. Top view of leg width: Leg square even width, corner to corner as ¾ inch for maximum plant weight support from the planter stand.

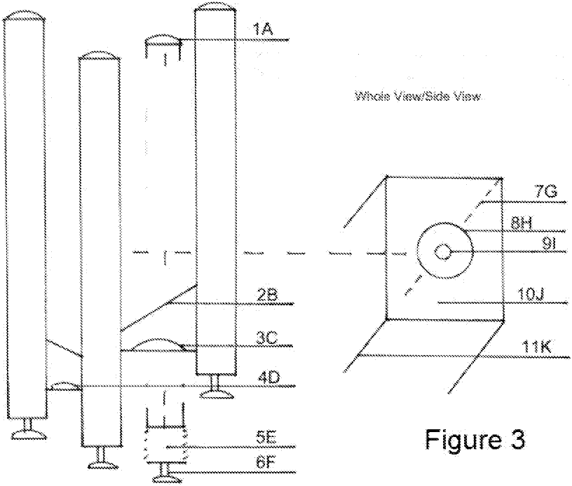

The FIG. 3 will show the whole view and side view of the planter stand and the components labeled from the FIG. 3. black drawings.
1A. Level Balancer: water bulbs the measure the balancing of the planter stand.
2B. Support Bracket: Connects the legs to the plant stand structure for highly durable support.
3C. Tray Compartment: Compartment to hold plant utility items for planting maintenance.
4D. Reservoir Water tank: emergency water technology to water remotely.
5E. Leg Stand: possible 4th leg for solid planter stand structure.
6F. Plant leg foot and threaded rod: adjustable by twisting counterclockwise and clockwise to increase height or decrease height to balance planter stand level.
7G. Top view of Planter stand: top overhead view if 4 legs are used corner to corner in a square positioning for solid structure base.
8H. Threaded mm Rod and case: Overhead view for the direct location in middle of planter stand.
9I. Momentary Switch: Overhead view of direct location, middie of plant stand, connected to threaded mm rod and case for support.
10J. Planter stand leg: corner to comer, top view of width, ¾ inch squared.
11K. Planter Stand leg: side view of width, ¾ inch width squared.

There are three main saucers that are in the AQUA WEIGHT stand, one: holds the springs and shock absorbers, that will prevent the planter pot from bottoming out against the saucer tray of planter pot weight from 1 lb to 40 lbs. The adjustment of rail arm that holds the momentary switch will help balance out the weight of the planter pot to insure proper indication of the led light.

The other two saucers are top trays, one: is the drain tray that hold the excess water or liquid from the top tray, second: tray that has drain holes and holds the planter pot. There is a momentary switch that is connected onto an adjustable rail stand with twist knobs. This is how the indicator light turn on and off by adjusting the head of the switch, flush to the bottom the two top trays, one being the drain tray and the other being the planter pot-holder tray. The adjustable rail has the callability of being adjusted by twisting the knobs back and forth to adjust the height vertically, on to the switches push button head. This is done to adjust to the weight of the planter pot; to make it more efficient of weighing the water or liquid that is added to the plant with planter pot and to adjust the planter pot weight itself. The Aqua-Weight is powered by 12 volt DC power supply adapter, that plugs into a standard 110 volt outlet. The power supply is a 12 volt adapter, connected to three waterproof led 12 volt lights; adding more led lights is an option.

There are three sets of adjustable feet pegs, added one each to each leg of the stands frame. The feet pegs can vertically lengthen or shorten by twisting them left or right, this will adjust the height of each frame leg of the stand. This allows the stand frame to be adjusted for perfect balance to hold the weight of the planter pot and when water or liquid is added. This will help with uneven countertop or shelving while using the Aqua-Weight product.

Aqua Weight stand wires from the lights, momentary push button switch, 9-volt wireless and corded main 12 volt DC options, are wrapped with vinyl and secured with zip ties, for professional look, updating can be explored.

There are two sub saucer (optional) that are connected to the stand for storage or other elements, located at bottom of stand between the balance bars of the structure stand. They can be removed and reclasped. There can be a single storage tray option in replace of the two saucer trays.

Aqua Weight has added three leveling water bulbs to the stand’s features. This feature will help make the stand balanced, on any surface and provide equal watering or liquidizing in the planter pot.

The leveling bulbs helps distribute the water or liquid equally and this will allow the plant to maintain a healthier growth.

The invention, Aqua-Weight, is a dual-weighing-mechanism-planter pot- stand. There are alerts shown and sent identifying that water is required. This is shown by illumination of led lights and reports transmitted from the planter pot. Aqua-Weight balances the saturated water levels in the planter pot, for a healthier plant life.
